(19) United States
(12) Patent Application Publication
(10) Pub. No.: US 2024/0064546 A1
(43) Pub. Date: Feb. 22, 2024

(54) L1 Inter-Cell Measurement Enhancement for Beam Management

(71) Applicant: Apple Inc., Cupertino, CA (US)

(72) Inventors: Haitong SUN, Cupertino, CA (US); Chunxuan YE, San Diego, CA (US); Dawei ZHANG, Saratoga, CA (US); Hong HE, San Jose, CA (US); Huaning NIU, San Jose, CA (US); Jie CUI, San Jose, CA (US); Oghenekome OTERI, San Diego, CA (US); Wei ZENG, Saratoga, CA (US); Yushu ZHANG, Beijing (CN)

(21) Appl. No.: 17/754,488

(22) PCT Filed: Apr. 6, 2021
(86) PCT No.: PCT/CN2021/085709

§ 371 Date: Apr. 4, 2022

(51) Int. Cl. H04W 24/10; H04B 7/06

(52) U.S. Cl. CPC H04W 24/10; H04B 7/0626

(57) ABSTRACT

A base station configures a user equipment (UE) to perform measurements. The base station configures the UE for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station and receives the CSI measurement report comprising the L1 measurement values for the neighbor base station.

### BACKGROUND INFORMATION

In 5G NR, measurements may be performed on one or more reference signals to determine channel properties. For example, a reference signal received power (RSRP) or a signal-to-noise and interference ratio (SINR) may be determined for layer 1 (L1) (physical layer) mobility measurements, e.g. L1-RSRP or L1-SINR, and reported to the network in a channel state information (CSI) report.

Multiple transmission and reception point (multi-TRP) functionality involves a user equipment (UE) maintaining multiple links with multiple TRPs (e.g. multiple gNBs) simultaneously on the same carrier. For example, a UE may be configured with a first TRP as a serving TRP and second TRP as a neighbor TRP in an inter-cell multi-TRP arrangement. However, it is not currently specified how to configure the UE to perform L1 mobility measurements for the neighbor TRP and report the same to the network.

### SUMMARY

Some exemplary embodiments are related to a processor of a base station configured to perform operations. The operations include configuring a user equipment (UE) for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station and receiving the CSI measurement report comprising the L1 measurement values for the neighbor base station.

Other exemplary embodiments are related to a base station having a transceiver configured to communicate with a user equipment (UE) and a processor communicatively coupled to the transceiver and configured to perform operations. The operations include configuring the UE for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station and receiving the CSI measurement report comprising the L1 measurement values for the neighbor base station.

Still further exemplary embodiments are related to a processor of a user equipment (UE) configured to perform operations. The operations include receiving a configuration from a base station for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station, performing channel measurements on the configured RS from the neighbor cell and computing the L1 measurement values for the neighbor cell and transmitting, to the base station, the CSI measurement report comprising the L1 measurement values for the neighbor base station.

Additional exemplary embodiments are related to a user equipment (UE) having a transceiver configured to communicate with a base station and a processor communicatively coupled to the transceiver and configured to perform operations. The operations include receiving a configuration from the base station for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station, performing channel measurements on the configured RS from the neighbor cell and computing the L1 measurement values for the neighbor cell and transmitting, to the base station, the CSI measurement report comprising the L1 measurement values for the neighbor base station.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary multi-TRP system according to various exemplary embodiments described herein.

FIG. 5 shows an exemplary CSI-ResourceConfig IE and an exemplary CSI-SSB-ResourceSet IE.

FIG. 6 shows an exemplary diagram for the various parameter levels at which the TRP parameters can be introduced for neighbor cell CSI-RS measurements.

FIG. 7 shows a method for configuring an L1 measurement report for L1-centric inter-cell mobility in a multi-TRP arrangement comprising a serving TRP and at least one neighbor TRP for a user equipment (UE).

### DETAILED DESCRIPTION

The exemplary embodiments may be further understood with reference to the following description and the related appended drawings, wherein like elements are provided with the same reference numerals. The exemplary embodiments describe operations for a serving cell to configure a user equipment (UE) to perform layer 1 (L1) mobility measurements for a neighbor cell in an inter-cell multiple transmission and reception point (TRP) (multi-TRP) arrangement. According to various exemplary embodiments, the UE may be configured to measure a synchronization signal block (SSB) and/or a channel state information (CSI) reference signal (CSI-RS) transmitted from the neighbor cell and report computed measurement values, such as an L1 reference signal received power (RSRP) (L1-RSRP) value or an L1 signal-to-noise and interference ratio (SINR) (L1-SINR) value, to the serving cell in a configured CSI report.

According to some embodiments described herein, certain parameters for the neighbor cell RS, e.g. SSB or CSI-RS, are explicitly configured by the serving cell or may be assumed by the UE. Various measurement restrictions and reporting conditions may be imposed, as described below. Additionally, operations for PDSCH rate matching are described.

### Network/Devices

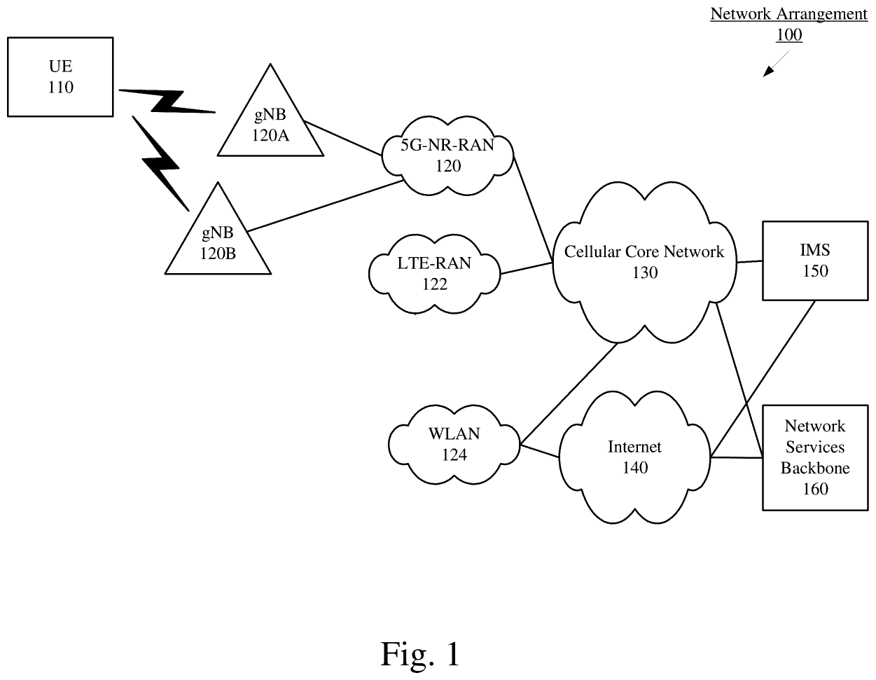

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., a component of a connected car, a mobile phone, a tablet computer, a smartphone, a phablet, an embedded device, a wearable, an Internet of Things (IoT) device, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g. legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. The gNBs 120A, 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. Reference to two gNBs 120A, 120B is merely for illustrative purposes. The exemplary embodiments may apply to any appropriate number of gNBs. Specifically, the UE 110 may simultaneously connect to and exchange data with a plurality of gNBs 120A, 120B in a multi-TRP configuration. The UE 110 may also connect to the LTE-RAN 122 or to any other type of RAN, as mentioned above. In the network arrangement 100, the UE 110 is shown as having a simultaneous connection to the gNBs 120A and 120B. The connections to the gNBs 120A, 120B may be, for example, multi-TRP connections where both of the gNBs 120A, 120B provide services for the UE 110 on a same channel.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

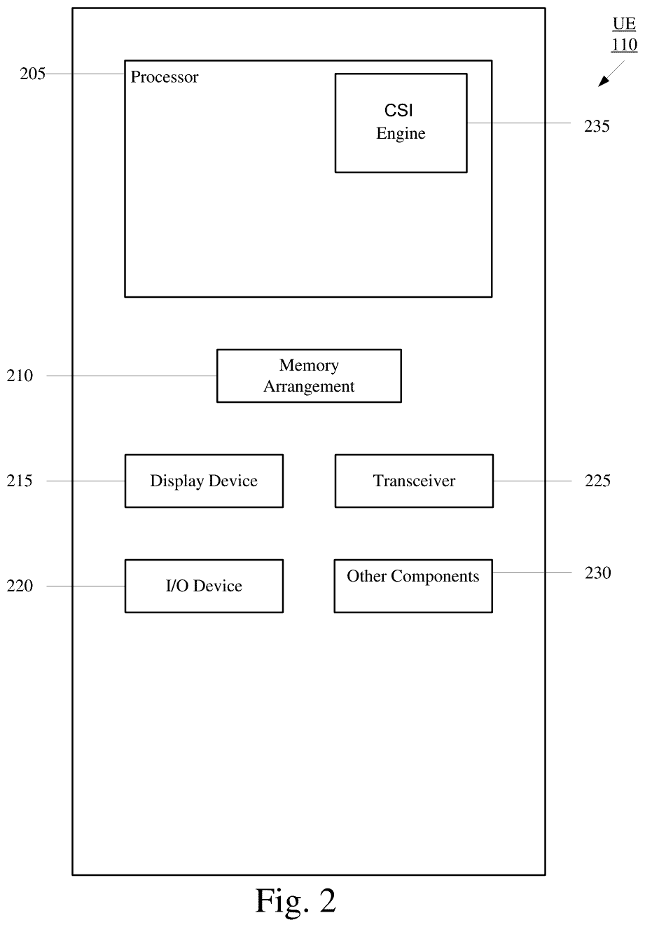

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a channel state information (CSI) engine 235. The CSI engine 235 may perform operations including performing CSI measurements on a neighbor cell in the TRP arrangement and generating a CSI report comprising L1 mobility measurements for the neighbor cell. The specific implementations for various scenarios will be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

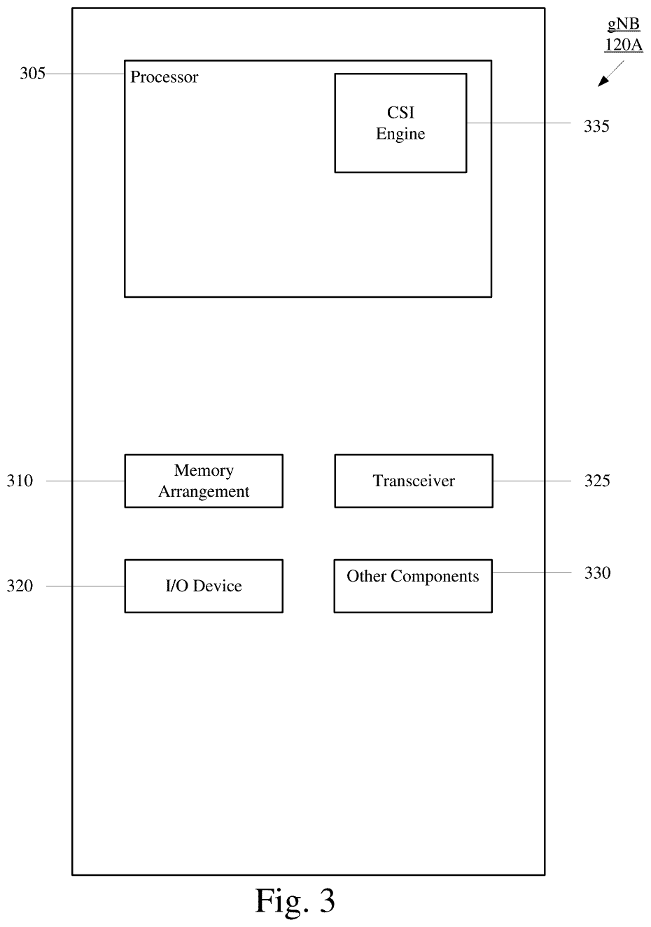

FIG. 3 shows an exemplary base station, in this case gNB 120A, according to various exemplary embodiments. As noted above with regard to the UE 110, the gNB 120A may represent a cell in a multi-TRP configuration with the UE 110. The gNB 120A may represent any access node of the 5G NR network through which the UEs 110, 112 may establish a connection and manage network operations. The gNB 120A illustrated in FIG. 3 may also represent the gNB 120B.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a CSI engine 335. The CSI engine 335 may perform operations including configuring a UE to perform CSI measurements on a neighbor cell in the multi-TRP arrangement and receiving from the UE a CSI report comprising L1 mobility measurements for the neighbor cell. The specific implementations for various scenarios will be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UEs 110, 112 and any other UE in the system 100, e.g. if the gNB 120A serves as a PCell or an SCell to either or both of the UEs 110, 112. The transceiver 325 may operate on a variety of different frequencies or channels (e.g., set of consecutive frequencies). Therefore, the transceiver 325 may include one or more components (e.g., radios) to enable the data exchange with the various networks and UEs.

### L1 Inter-Cell Measurement

Multiple transmission and reception point (multi-TRP) functionality involves a user equipment (UE) maintaining multiple links with multiple TRPs (e.g. multiple gNBs) simultaneously on the same carrier. For example, a UE may be configured with a first TRP as a serving TRP and second TRP as a neighbor TRP in an inter-cell multi-TRP arrangement. The exemplary embodiments described herein provide operations to support L1 measurement enhancement for L1-centric inter-cell mobility.

A reference signal received power (RSRP) may be determined for layer 1 (L1) (physical layer). An L1-RSRP measurement may be determined from RS measurements including a synchronization signal block (SSB) (PBCH-DMRS) (SS-RSRP) or a channel state information (CSI) reference signal (CSI-RS) (CSI-RSRP). An L1 signal-to-noise and interference (SINR) ratio may also be determined from RS measurements including CSI-RS or SSB as channel measurement resources (CMR) and/or interference measurement resources (IMR).

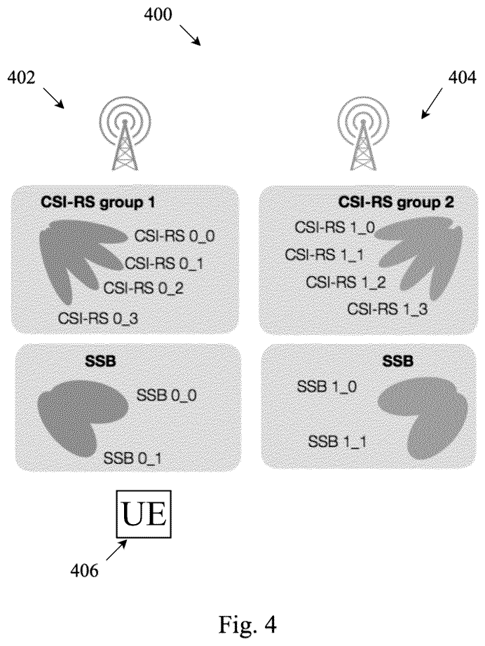

FIG. 4 shows an exemplary multi-TRP system 400 according to various exemplary embodiments described herein. The system 400 includes a first TRP 402 and a second TRP 404. As described above, the TRPs 402 and 404 may be separate base stations (e.g., gNB 120A and gNB 120B) or may be different panels on the same base station, etc. The first TRP 402 is a serving TRP for a UE 406 and the second TRP 404 is a neighbor TRP for the UE 406. Each of the TRPs 402, 404 may be configured to transmit a plurality of reference signals (RS) having different beam configurations. For example, the first TRP 402 may be configured to transmit a first CSI-RS group including e.g. four CSI-RS (CSI-RS 0_0, CSI-RS 0_1, CSI-RS 0_2 and CSI-RS 0_3), and two SSB (SSB 0_0 and SSB 0_1). The second TRP 404 may be configured to transmit a second CSI-RS group including e.g. four CSI-RS (CSI-RS 1_0, CSI-RS 1_1, CSI-RS 1_2 and CSI-RS 1_3), and two SSB (SSB 1_0 and SSB 1_1).

Existing operations may be used for transmitting the various RS from the multiple TRPs. However, it is not currently specified how to configure the UE 406 to measure RS from a neighbor cell (e.g., TRP 404) for generating a CSI report including L1 mobility measurements for the neighbor cell for transmission to the network. According to various exemplary embodiments described herein, operations are described for configuring a UE to perform measurements on neighbor cell SSB and CSI-RS for generating an L1-centric inter-cell mobility report. Various measurement restrictions and reporting conditions may be imposed. Additionally, operations for PDSCH rate matching are described.

It will be understood by persons skilled in the art that the UE may be configured to perform measurements on RS from any number of neighbor cells according to the various exemplary embodiments described herein. That is, various embodiments may be described with respect to a two-TRP arrangement, in which a first TRP is a serving cell and a second TRP is a neighbor cell for a UE. However, the TRP-arrangement for a UE may include any number of neighbor cells and the UE may be configured for RS measurement and CSI reporting for further neighbor cells in a similar manner as described below.

Additionally, as mentioned above, the information element (IE) used for configuring the UE is described as CSI-ReportConfig. However, the exemplary embodiments may be applicable to other means for configuring a CSI report for a UE.

### Neighbor Cell SSB Configuration

According to some exemplary embodiments, the serving TRP in a multi-TRP arrangement, e.g. the first TRP 402, may configure a UE, e.g. UE 406, to perform measurements on an SSB transmitted from a neighbor TRP, e.g. the second TRP 404. The L1 measurement report configuration may comprise, e.g., a CSI-ReportConfig information element (IE) configured by higher layers, e.g., the radio resource control (RRC) layer. The CSI-ReportConfig, according to the exemplary embodiments, is designed to include one or more parameters for measuring the SSB of the neighbor TRP. The SSB measurements for the neighbor TRP may be processed to generate L1 neighbor cell measurement values, e.g. L1-RSRP, L1-SINR, etc., for inclusion in the configured CSI report.

The following parameters may be configured for the UE and/or assumed, as described below. The first/serving TRP can configure 1) a physical cell ID (physCellId), 2) an SSB frequency domain pattern/location (ssbFrequency), 3) an SCS of the SSB (ssbSubcarrierSpacing), 4) an SSB time domain pattern (ssb-PositionsInBurst, SSB-ToMeasure, ssb-periodicity), 5) a transmit power of the SSB (ss-PBCH-BlockPower), and/or 6) a measurement offset for L1-RSRP or L1-SINR (Q-OffsetRangeList, configured differently for L1-RSRP; L1-SINR). Alternatively, the parameters 2-6 listed above (with the exception of the first parameter for the physical cell ID) may be assumed by the UE to be the same as the serving cell.

The additional SSB parameters listed above may be configured in the following manners using the CSI-ReportConfig IE.

In a first option, in a CSI-ReportConfig, multiple lists of CSI-ResourceConfig may be configured. In each CSI-ResourceConfig, the additional one or more parameters, including at least the physical cell ID for the TRP, may be configured for the one or more neighbor TRPs.

In a second option, in a single CSI-ResourceConfig, multiple lists of CSI-SSB-ResourceSetList may be configured. In the CSI-ResourceConfig, the additional one or more parameters can be configured for the one or more neighbor TRPs. In a third option, in a single CSI-ResourceConfig, a single list of CSI-SSB-ResourceSetList may be configured. In each CSI-SSB-ResourceSet, the additional one or more parameters may be configured.

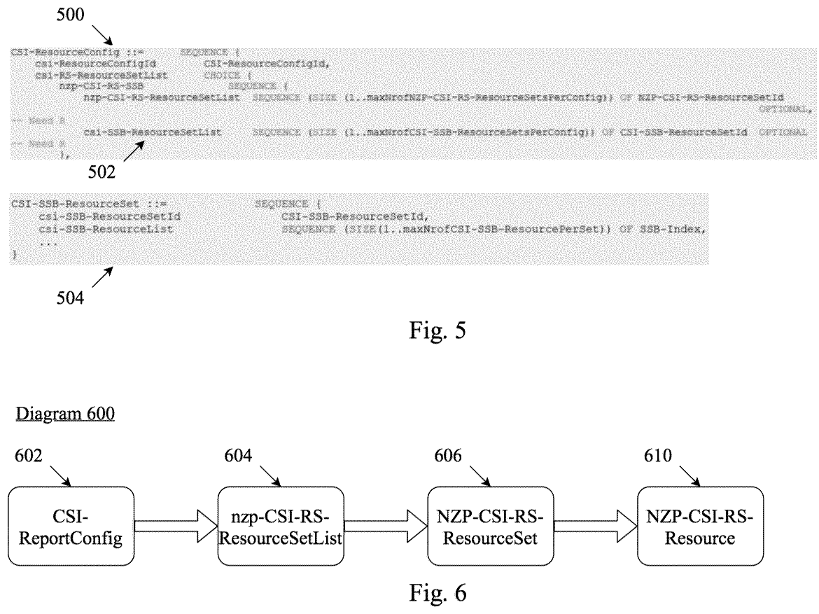

FIG. 5 shows an exemplary CSI-ResourceConfig IE 500 and an exemplary CSI-SSB-ResourceSet IE 504. As shown, the CSI-SSB-ResourceSetList 502 is a parameter for the CSI-ResourceConfig 500. The CSI-SSB-ResourceSet 504 is a parameter for the CSI-SSB-ResourceSetList 502. According to the options described above, the additional TRP parameters for configuring the neighbor cell measurement may be configured at the CSI-ReportConfig level (in each of the multiple lists of CSI-ResourceConfig of option 1), at the CSI-ResourceConfig level (in the single CSI-ResourceConfig of option 2) or at the CSI-SSB-ResourceSet level (in each CSI-SSB-ResourceSet included in the CSI-SSB-ResourceSetList of option 3).

### Neighbor Cell CSI-RS Configuration

According to other exemplary embodiments, the serving TRP in a multi-TRP arrangement, e.g. the first TRP 402, may configure a UE, e.g. UE 406, to perform measurements on a CSI-RS transmitted from a neighbor TRP, e.g. the second TRP 404. The L1 measurement report configuration may comprise, e.g., a CSI-ReportConfig information element (IE) configured by higher layers, e.g., the radio resource control (RRC) layer. The CSI-ReportConfig IE, according to the exemplary embodiments, is designed to include one or more parameters for measuring the CSI-RS of the neighbor TRP. The CSI-RS measurements for the neighbor TRP may be processed to generate L1 neighbor cell measurement values, e.g., L1-RSRP, L1-SINR, etc., for inclusion in the configured CSI report.

The following parameters may be configured for the UE and/or assumed, as described below. The first/serving TRP can configure 1) a physical cell ID (physCellId), 2) a reference point (point A) for the CSI-RS frequency domain pattern/location configuration (refFreqCSI-RS) in the resource grid, 3) a SCS of the CSI-RS (subcarrierSpacing), 4) a transmit power offset of the CSI-RS to the secondary synchronization signal (SSS) (powerControlOffsetSS), and 5) a measurement offset for L1-RSRP or L1-SINR (Q-OffsetRangeList).

The first parameter (physical cell ID) may be configured either explicitly in the CSI-ReportConfig, or determined from a scramblingID configured for a NZP-CSI-RS-Resource. The fourth parameter (transmit power offset) may be configured either with respect to the serving cell SSS or with respect to the corresponding cell SSS. The fifth parameter (measurement offset) may be differently depending on whether L1-RSRP or L1-SINR is configured. The second, third and fifth parameters listed above (with the exception of the physical cell ID and transmit power offset)) may be assumed by the UE to be the same as the serving cell, and thus not explicitly configured.

The additional CSI-RS parameters listed above may be configured in the following manners.

In a first option, in CSI-ReportConfig, multiple lists of CSI-ResourceConfig may be configured. In each CSI-ResourceConfig, the additional one or more parameters can be configured for each TRP.

In a second option, in a single CSI-ResourceConfig, multiple lists of NZP-CSI-RS-ResourceSetList may be configured. In the CSI-ResourceConfig, the additional one or more parameters can be configured for each TRP.

In a third option, in a single CSI-ResourceConfig, a single list of NZP-CSI-RS-ResourceSetList may be configured. In each NZP-CSI-RS-ResourceSet, the additional one or more parameters can be configured.

In a fourth option, in each configured NZP-CSI-RS-Resource, the additional one or more parameters may be configured.

FIG. 6 shows an exemplary diagram 600 for the various parameter levels at which the TRP parameters can be introduced for neighbor cell CSI-RS measurements. According to the options described above, the additional TRP parameters for configuring the neighbor cell measurement may be configured at the CSI-ReportConfig level 602 (in each of the multiple lists of CSI-ResourceConfig of option 1), at the NZP-CSI-RS-ResourceSetList level 604 (in the single CSI-Resource-Config of option 2), at the NZP-CSI-RS-ResourceSet level 606 (in each NZP-CSI-RS-ResourceSet included in the NZP-CSI-RS-ResourceSetList in a single CSI-ResourceConfig of option 3, or at the NZP-CSI-RS-Resource level 610 (of option 4).

### Measurement Restrictions

For a CSI-RS from the neighbor cell configured for the L1 mobility measurement report, the following restrictions may be considered with respect to the time domain pattern for the resources. In a first option, only periodic CSI-RS may be used for the L1 mobility measurement. In a second option, only periodic and semi-persistent CSI-RS may be used for L1 mobility measurement. In a third option, any one of periodic, semi-persistent, or aperiodic CSI-RS may be used for the L1 mobility measurement, but all CSI-RS resources in the same L1 mobility measurement should have the same time domain pattern. The first option provides the predictable UE behavior for the network, while the third option provides flexibility to the network.

For either one of a CSI-RS or an SSB from the neighbor cell configured for the L1 mobility measurement report, the following restrictions may be considered with respect to the time domain pattern for the resources. In a first option, the resources are configured to fully overlap in the time domain. In a second option, the resources may be configured for non-overlap or partial overlap in the time domain. The first option may minimize the amount of time the UE spends conducting channel measurements, and thus minimizes the UE power consumption spent measuring the neighbor cell RS, while the second option provides flexibility to the network.

For either one of a CSI-RS or an SSB from the neighbor cell configured for the L1 mobility measurement report, the following restrictions may be considered with respect to the frequency domain pattern for the resources. In a first option, the resources are configured to fully overlap in the frequency domain. In a second option, the resources may be configured for non-overlap or partial overlap in the frequency domain.

For either one of a CSI-RS or SSB from the neighbor cell configured for the L1 mobility measurement report, the following restrictions may be considered with respect to the subcarrier spacing (SCS). In a first option, all CSI-RS from all cells should have the same SCS. In a second option, CSI-RS from different cells may have a different SCS. In a third option, all SSB from all cells should have the same SCS. In a fourth option SSB from different cells may have a different SCS.

Some UEs may be able to handle only one SCS at a time. Thus, when the CSI-RS or SSB from the neighbor cell has a SCS different from the serving cell, a measurement gap window may be configured for the UE during which the UE may tune away from the serving cell to the neighbor cell. During the measurement gap window, the UE is not required to monitor the current serving cell and may tune to the neighbor cell.

### Report Conditions

When the L1 mobility measurement is configured, either one or both of L1-RSRP or L1-SINR may be reported according to the following options. In a first option, the UE reports the regular L1 measurement without considering any further conditions. In other words, for a periodic and semi-persistent report, the measurement quantity is reported for every configured periodicity. For an aperiodic report, the measurement quantity is reported with a triggered time offset.

In a second option, the L1 measurement is reported when one or more conditions are met. In one example, the quality of the channel conditions for the serving cell may be used as a reference value, and the L1 mobility measurement may be reported only when the quality of the channel for the neighbor cell (as determined in e.g. an L1-RSRP or L1-SINR value) is better than that of the serving cell by more than a configured threshold (hysteresis). Additionally, the above condition may be considered over a time span. For example, the L1 mobility measurement may be reported only when the quality of the channel for the neighbor cell is better than that of the serving cell for at least a preconfigured duration or number of samples (time to trigger).

The UE may consume less power when the L1 measurements are reported only when certain conditions are met. However, this conditional reporting reduces the information available to the network.

### Rate Matching

When CSI-RS/SSB from the neighbor cell is configured for the L1 mobility measurement report, rate matching may be performed for the PDSCH transmitted from either one or both of the TRPs, as described below. Rate matching refers to the PDSCH being scheduled to avoid the subcarriers of a reference signals, which in this case may include signals such as the CSI-RS and/or SSB configured for the serving TRP measurement or for the neighbor TRP measurement.

In a first option, separate rate matching may be used. For the PDSCH scheduled by a particular cell, e.g. TRP1, the UE rate matches only with the CSI-RS and/or SSB configured in the corresponding cell (TRP1) and does not rate match with any RS configured in the other cell (TRP2).

In a second option, joint rate matching may be used. For the PDSCH scheduled by a particular cell, e.g. TRP1, the UE rate matches with the CSI-RS and/or SSB configured in all cells (TRP1 and TRP2)

If either of the two options discussed above (separate or joint rate matching) are supported by the UE, the UE capability can be reported to the serving TRP. In a first option, the UE independently reports whether separate and/or joint rate matching is supported. In a second option, support of one of the rate matching capabilities may be a prerequisite for support of the other one of the capabilities. Thus, if support of joint rate matching is a prerequisite for separate rate matching, then support of joint rate matching may be reported (indicating only joint rate matching is supported) or support of separate rate matching may be reported to indicate that both of the capabilities are supported. If support of separate rate matching is a prerequisite for joint rate matching, then support of separate rate matching may be reported (indicating only separate rate matching is supported) or support of joint rate matching may be reported to indicate that both of the capabilities are supported.

Additionally, the network can further configure the UE to perform either joint or separate rate matching via, e.g., RRC signaling.

### Methods

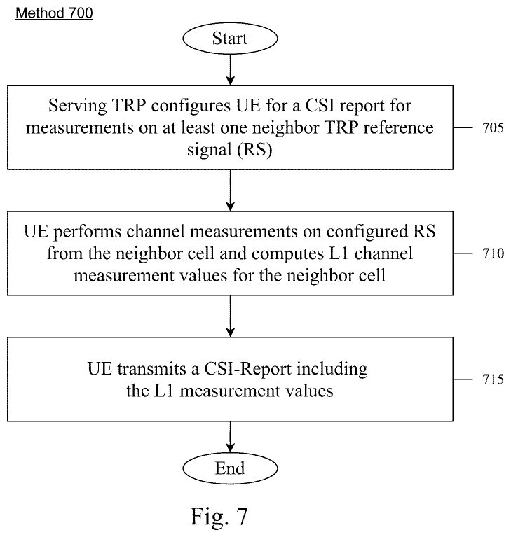

FIG. 7 shows a method 700 for configuring an L1 measurement report for L1-centric inter-cell mobility in a multi-TRP arrangement comprising a serving TRP and at least one neighbor TRP for a user equipment (UE).

In 705, the serving TRP configures the UE for a CSI report for measurements on at least one neighbor TRP reference signal (RS). As described above, the neighbor TRP RS may be an SSB or a CSI-RS. The parameters used for the CSI report configuration are described above and may be either explicitly indicated in an IE, e.g. a CSI-ReportConfig, or assumed by the UE based on other configured parameters, e.g., parameters used for measurements on the serving TRP.

The configuration may be subject to various restrictions with respect to the time domain pattern, the frequency domain pattern, or the SCS of the configured RS, as described above.

In 710, the UE performs the channel measurements on the configured RS from the neighbor cell and computes L1 channel measurement values for the neighbor cell, such as L1-RSRP and L1-SINR. In some embodiments, the UE performs rate matching for a PDSCH scheduled by a TRP for RS configured for that TRP (separate rate matching) or for RS configured for both TRPs (joint rate matching). The UE may have previously indicated to the serving TRP whether one or both types of rate matching were supported by UE capability.

In 715, the UE transmits a CSI-Report including the L1 measurement values. The UE may report the L1 measurements every configured periodicity (periodic and semi-persistent reports) or after a time offset (for aperiodic reports). Alternatively, the UE may report the L1 measurements only when certain conditions are met.

### Examples

In a first example, a base station comprising a transceiver configured to communicate with a user equipment (UE) and a processor communicatively coupled to the transceiver and configured to perform operations is provided. The operations include configuring the UE for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station and receiving the CSI measurement report comprising the L1 measurement values for the neighbor base station.

In a second example, the base station of the first example, wherein the RS transmitted from the neighbor base station is a synchronization signal block (SSB) and the parameters for the SSB include a physical cell identifier, a frequency domain pattern, a subcarrier spacing, a time domain pattern, a transmit power and a measurement offset.

In a third example, the base station of the second example, wherein the physical cell identifier is explicitly configured and wherein one or more of the remaining parameters is assumed to have a same parameter value as a parameter value for an SSB configured to be transmitted from the base station.

In a fourth example, the base station of the second example, wherein the CSI measurement report configuration for the neighbor base station SSB includes a CSI-ReportConfig, wherein the one or more parameters for the SSB to be measured from the neighbor base station are introduced at a CSI-ReportConfig level, a CSI-ResourceConfig level or a CSI-SSB-ResourceSet level.

In a fifth example, the base station of the first example, wherein the RS transmitted from the neighbor base station is a CSI reference signal (CSI-RS) and the parameters for the CSI-RS include a physical cell identifier, a reference point for a frequency domain pattern, a subcarrier spacing, a transmit power offset and a measurement offset.

In a sixth example, the base station of the fifth example, wherein the physical cell identifier is explicitly configured or determined from a scrambling ID configured for a non-zero-power CSI-RS (NZP-CSI-RS).

In a seventh example, the base station of the fifth example, wherein the transmit power offset is determined with respect to a secondary synchronization signal (SSS) transmitted from the base station or from the neighbor base station.

In an eighth example, the base station of the fifth example, wherein one or more of the reference point for the frequency domain pattern, the subcarrier spacing, or the measurement offset is assumed to have a same parameter value as a parameter value for a CSI-RS configured to be transmitted from the base station.

In a ninth example, the base station of the fifth example, wherein the CSI measurement report configuration for the neighbor cell CSI-RS includes a CSI-ReportConfig, wherein the one or more parameters for the CSI-RS to be measured from the neighbor base station are introduced at a CSI-ReportConfig level, at a NZP-CSI-RS-ResourceSetList level, at NZP-CSI-RS-ResourceSet level, or at a NZP-CSI-RS-Resource level.

In a tenth example, the base station of the first example, wherein the RS is a CSI reference signal (RS) and the CSI-RS is configured only as a periodic CSI-RS.

In an eleventh example, the base station of the first example, wherein the RS is a CSI reference signal (RS) and the CSI-RS is configured only as a periodic CSI-RS or a semi-persistent CSI-RS.

In a twelfth example, the base station of the first example, wherein a plurality of RS are configured for the CSI measurement report and the RS are configured to fully overlap in the time domain.

In a thirteenth example, the base station of the first example, wherein a plurality of RS are configured for the CSI measurement report and the RS are configured to not overlap in the time domain.

In a fourteenth example, the base station of the first example, wherein a plurality of RS are configured for the CSI measurement report and the RS are configured to fully overlap in the frequency domain.

In a fifteenth example, the base station of the first example, wherein a plurality of RS are configured for the CSI measurement report and the RS are configured to not overlap in the frequency domain.

In a sixteenth example, the base station of the first example, wherein a plurality of RS are configured for the CSI measurement report and the RS are configured to have a same subcarrier spacing.

In a seventeenth example, the base station of the first example, wherein a plurality of RS are configured for the CSI measurement report and at least one of the RS is configured to have a subcarrier spacing different from another one of the RS, wherein the operations further comprise configuring a measurement gap during which the UE is not required to monitor the base station and tunes to the neighbor base station.

In an eighteenth example, the base station of the first example, wherein the operations further comprise receiving an indication from the UE for whether rate matching to the reference signal transmitted from the neighbor base station is supported and configuring the UE to perform rate matching between a physical downlink shared channel (PDSCH) and the one or more configured RS.

In a nineteenth example, the base station of the first example, wherein the CSI measurement report comprises an L1 reference signal received power (RSRP) (L1-RSRP) or an L1 signal-to-noise and interference ratio (SINR) (L1-SINR)

In a twentieth example, a user equipment (UE) comprising a transceiver configured to communicate with a base station and a processor communicatively coupled to the transceiver and configured to perform operations is provided. The operations include receiving a configuration from the base station for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station, performing channel measurements on the configured RS from the neighbor cell and computing the L1 measurement values for the neighbor cell and transmitting, to the base station, the CSI measurement report comprising the L1 measurement values for the neighbor base station.

In a twenty first example, the UE of the twentieth example, wherein the RS transmitted from the neighbor base station is a synchronization signal block (SSB) and the parameters for the SSB include a physical cell identifier, a frequency domain pattern, a subcarrier spacing, a time domain pattern, a transmit power and a measurement offset.

In a twenty second example, the UE of the twenty first example, wherein the physical cell identifier is explicitly configured and wherein the operations further comprise determining one or more of the remaining parameters to have a same parameter value as a parameter value for an SSB configured to be transmitted from the base station.

In a twenty third example, the UE of the twenty first example, wherein the CSI measurement report configuration for the neighbor base station SSB includes a CSI-ReportConfig, wherein the one or more parameters for the SSB to be measured from the neighbor base station are introduced at a CSI-ReportConfig level, a CSI-ResourceConfig level or a CSI-SSB-ResourceSet level.

In a twenty fourth example, the UE of the twentieth example, wherein the RS transmitted from the neighbor base station is a CSI reference signal (CSI-RS) and the parameters for the CSI-RS include a physical cell identifier, a reference point A for a frequency domain pattern, a subcarrier spacing, a transmit power offset and a measurement offset.

In a twenty fifth example, the UE of the twenty fourth example, wherein the physical cell identifier is explicitly configured or determined from a scrambling ID configured for a non-zero-power CSI-RS (NZP-CSI-RS).

In a twenty sixth example, the UE of the twenty fourth example, wherein the transmit power offset is determined with respect to a secondary synchronization signal (SSS) transmitted from the base station or from the neighbor base station.

In a twenty seventh example, the UE of the twenty fourth example, wherein one or more of the reference point for the frequency domain pattern, the subcarrier spacing, or the measurement offset is assumed to have a same parameter value as a parameter value for an SSB configured to be transmitted from the base station.

In a twenty eighth example, the UE of the twenty fourth example, wherein the CSI measurement report configuration for the neighbor cell CSI-RS includes a CSI-ReportConfig, wherein the one or more parameters for the CSI-RS to be measured from the neighbor gNB are introduced at a CSI-ReportConfig level, at a NZP-CSI-RS-ResourceSetList level, at NZP-CSI-RS-ResourceSet level, or at a NZP-CSI-RS-Resource level.

In a twenty ninth example, the UE of the twentieth example, wherein the RS is a CSI reference signal (RS) and the CSI-RS is configured only as a periodic CSI-RS.

In a thirtieth example, the UE of the twentieth example, wherein the RS is a CSI reference signal (RS) and the CSI-RS is configured only as a periodic CSI-RS or a semi-persistent CSI-RS.

In a thirty first example, the UE of the twentieth example, wherein a plurality of RS are configured for the CSI measurement report and the RS are configured to fully overlap in the time domain.

In a thirty second example, the UE of the twentieth example, wherein a plurality of RS are configured for the CSI measurement report and the RS are configured to not overlap in the time domain.

In a thirty third example, the UE of the twentieth example, wherein a plurality of RS are configured for the CSI measurement report and the RS are configured to fully overlap in the frequency domain.

In a thirty fourth example, the UE of the twentieth example, wherein a plurality of RS are configured for the CSI measurement report and the RS are configured to not overlap in the frequency domain.

In a thirty fifth example, the UE of the twentieth example, wherein a plurality of RS are configured for the CSI measurement report and the RS are configured to have a same subcarrier spacing.

In a thirty sixth example, the UE of the twentieth example, wherein a plurality of RS are configured for the CSI measurement report and at least one of the RS is configured to have a subcarrier spacing different from another one of the RS, wherein the operations further comprise receiving a configuration for a measurement gap during which the UE is not required to monitor the base station and tuning to the neighbor base station to perform the channel measurements during the measurement gap.

In a thirty seventh example, the UE of the twentieth example, wherein the CSI measurement report is transmitted for every configured periodicity for periodic and semi-persistent reports and after a time offset for aperiodic reports.

In a thirty eighth example, the UE of the twentieth example, wherein the CSI measurement report is transmitted only when a quality of a channel for the neighbor base station is determined to be better than a quality of a channel for the base station.

In a thirty ninth example, the UE of the twentieth example, wherein the CSI measurement report is transmitted only when a quality of a channel for the neighbor base station is determined to be better than a quality of a channel for the base station for at least a predetermined duration or number of samples.

In a fortieth example, the UE of the twentieth example, wherein the operations further comprise indicating to the base station whether rate matching is supported by the UE and receiving a configuration to perform rate matching between a physical downlink shared channel (PDSCH) and the one or more configured RS.

In a forty first example, the UE of the fortieth example, wherein the operations further comprise indicating to the base station whether at least one of separate rate matching or joint rate matching is supported, wherein separate rate matching comprises rate matching between a PDSCH and RS transmitted from a same base station and joint rate matching comprises rate matching between a PDSCH transmitted from one base station and RS transmitted from any of the base stations.

In a forty second example, the UE of the twentieth example, wherein the CSI measurement report comprises an L1 reference signal received power (RSRP) (L1-RSRP) or an L1 signal-to-noise and interference ratio (SINR) (L1-SINR)

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a base station configured to perform operations comprising:
configuring a user equipment (UE) for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station; and
receiving the CSI measurement report comprising the L1 measurement values for the neighbor base station.

2. The processor of claim 1, wherein the RS transmitted from the neighbor base station is a synchronization signal block (SSB) and the parameters for the SSB include a physical cell identifier, a frequency domain pattern, a subcarrier spacing, a time domain pattern, a transmit power and a measurement offset.

3. The processor of claim 2, wherein the physical cell identifier is explicitly configured and wherein one or more of the remaining parameters is assumed to have a same parameter value as a parameter value for an SSB configured to be transmitted from the base station.

4. The processor of claim 2, wherein the CSI measurement report configuration for the neighbor base station SSB includes a CSI-ReportConfig, wherein the one or more parameters for the SSB to be measured from the neighbor base station are introduced at a CSI-ReportConfig level, a CSI-ResourceConfig level or a CSI-SSB-ResourceSet level.

5. The processor of claim 1, wherein the RS transmitted from the neighbor base station is a CSI reference signal (CSI-RS) and the parameters for the CSI-RS include a physical cell identifier, a reference point for a frequency domain pattern, a subcarrier spacing, a transmit power offset and a measurement offset.

6-9. (canceled)

10. The processor of claim 1, wherein the RS is a CSI reference signal (RS) and the CSI-RS is configured only as a periodic CSI-RS.

11. The processor of claim 1, wherein the RS is a CSI reference signal (RS) and the CSI-RS is configured only as a periodic CSI-RS or a semi-persistent CSI-RS.

12. The processor of claim 1, wherein a plurality of RS are configured for the CSI measurement report and the RS are configured to fully overlap in the time domain.

13. The processor of claim 1, wherein a plurality of RS are configured for the CSI measurement report and the RS are configured to not overlap in the time domain.

14. The processor of claim 1, wherein a plurality of RS are configured for the CSI measurement report and the RS are configured to fully overlap in the frequency domain.

15. The processor of claim 1, wherein a plurality of RS are configured for the CSI measurement report and the RS are configured to not overlap in the frequency domain.

16. The processor of claim 1, wherein a plurality of RS are configured for the CSI measurement report and the RS are configured to have a same subcarrier spacing.

17. The processor of claim 1, wherein a plurality of RS are configured for the CSI measurement report and at least one of the RS is configured to have a subcarrier spacing different from another one of the RS, wherein the operations further comprise:
configuring a measurement gap during which the UE is not required to monitor the base station and tunes to the neighbor base station.

18. The processor of claim 1, wherein the operations further comprise:
receiving an indication from the UE for whether rate matching to the reference signal transmitted from the neighbor base station is supported; and
configuring the UE to perform rate matching between a physical downlink shared channel (PDSCH) and the one or more configured RS.

19. The processor of claim 1, wherein the CSI measurement report comprises an L1 reference signal received power (RSRP) (L1-RSRP) or an L1 signal-to-noise and interference ratio (SINR) (L1-SINR)

20. A processor of a user equipment (UE) configured to perform operations comprising:
receiving a configuration from a base station for a channel state information (CSI) measurement report comprising layer 1 (L1) measurement values for one or more reference signals (RS) transmitted from a neighbor base station, wherein the CSI measurement report configuration includes an indication of one or more parameters for each of the RS to be measured from the neighbor base station;
performing channel measurements on the configured RS from the neighbor cell and computing the L1 measurement values for the neighbor cell; and
transmitting, to the base station, the CSI measurement report comprising the L1 measurement values for the neighbor base station.

21. The processor of claim 20, wherein the RS transmitted from the neighbor base station is a synchronization signal block (SSB) and the parameters for the SSB include a physical cell identifier, a frequency domain pattern, a subcarrier spacing, a time domain pattern, a transmit power and a measurement offset.

22-23. (canceled)

24. The processor of claim 20, wherein the RS transmitted from the neighbor base station is a CSI reference signal (CSI-RS) and the parameters for the CSI-RS include a physical cell identifier, a reference point A for a frequency domain pattern, a subcarrier spacing, a transmit power offset and a measurement offset.

25-30. (canceled)

31. The processor of claim 20, wherein a plurality of RS are configured for the CSI measurement report and the RS are configured to fully overlap in a time domain or a frequency domain.

32. The processor of claim 20, wherein a plurality of RS are configured for the CSI measurement report and the RS are configured to not overlap in a time domain or a frequency domain.

33-42. (canceled)
